(19) United States
(12) Patent Application Publication
(10) Pub. No.: US 2022/0051302 A1
(43) Pub. Date: Feb. 17, 2022

(54) System and Method for Facilitating Funds Transfer

(71) Applicant: Christopher Alan Wall, Rochester, MN (US)

(72) Inventor: Christopher Alan Wall, Rochester, MN (US)

(21) Appl. No.: 17/298,075

(22) PCT Filed: Nov. 26, 2019
(86) PCT No.: PCT/US2019/063411

§ 371 Date: May 28, 2021

Related U.S. Application Data
(60) Provisional application No. 62/772,908, filed on Nov. 29, 2018.

(51) Int. Cl. G06Q 30/02; G06Q 20/32; G06Q 20/06

(52) U.S. Cl. CPC G06Q 30/0279; G06Q 20/065; G06Q 20/3276; G06Q 20/3224

(57) ABSTRACT

A computer implemented method includes scanning a code by a user device, the code identifying an organization donation page corresponding to the code, providing the code to a donation webpage server, wherein the server accesses the organization donation page corresponding to the code, receiving and displaying the donation page on the user device, receiving a selection of a donation amount at the user device, and transferring funds from a user account to an organization account in response to the received

### RELATED APPLICATION

This application claims priority to U.S. Provisional Application Ser. No. 62/772,908 (entitled System and Method for Facilitating Funds Transfer, filed Nov. 29, 2018) which is incorporated herein by reference.

### FIELD

The present invention relates to transfer of funds, and in particular to an integrated, organized infrastructure platform that can be quickly, simply and safely deployed in a variety of settings to digitally transfer funds.

### BACKGROUND

Most attempts to raise money tor causes experience significant technical challenges and multiple steps for both the organization setup and the donor. This is due to cumbersome and disparate systems for online navigation, registration, payment processing, accounting and marketing. Large scale organizations are able to employ a group of dedicated staff to solve technical challenges related to their unique organizational needs. However, small to medium-size organizations are much more limited in their ability to create and integrate the multiple components to successfully create and maintain a successful fundraising cause.

These technical barriers result in lost opportunities to complete and effectively transfer funds. Therefore, organizations must default to the use of “paper currency” or “checks” to receive and process funds at a single point of sale. The paper transaction process adds to the challenges and expenses incurred for less agile organizations throughout the process—from the initial transaction the additional steps required to further collate, process, provide a follow-up receipt and accurately account for the transaction.

### SUMMARY

A computer implemented method includes scanning a code by a user device, the code identifying an organization donation page corresponding to the code, providing the code to a donation webpage server, wherein the server accesses the organization donation page corresponding to the code, receiving and displaying the donation page on the user device, receiving a selection of a donation amount at the user device, and transferring funds from a user account to an organization account in response to the received selection.

### BRIEF DESCRIPTION OF THE DRAWINGS

FIG. 1 is a block flow diagram illustrating use of a platform for facilitating fundraising for organizations according to an example embodiment.

FIG. 2 is a flowchart illustrating a method of generating a code in response to a request from an organization according to an example embodiment.

FIG. 3 is a block flow diagram illustrating use of a platform for creating a customizable donation page according to an example embodiment.

FIG. 4 is a block flow diagram illustrating use of a platform for transferring funds based on an alphanumeric code according to an example embodiment.

FIG. 5 is a block flow diagram illustrating use of a platform for transferring funds based on a QR code according to an example embodiment.

FIG. 6 is a block flow diagram illustrating use of a platform for transferring funds based on a geofenced location according to an example embodiment.

FIG. 7 is a block flow diagram illustrating use of a platform for transferring funds based on social media platforms code according to an example embodiment.

FIG. 8 is a block flow diagram. illustrating use of a platform for transferring funds based on a map of coded donation locations according to an example embodiment.

FIG. 9 is a block schematic diagram of a computer system to implement and manage the use of codes for simplifying donation and purchasing mechanisms according to an example embodiment.

### DETAILED DESCRIPTION

In the following description, reference is made to the accompanying drawings that form a part hereof, and in which is shown by way of illustration specific embodiments which may he practiced. These embodiments are described in sufficient detail to enable those skilled in the art to practice the invention, and it is to he understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may he software, hardware, firmware or any combination thereof. Multiple functions may he performed in one or more modules as desired, and the embodiments described are merely examples. The software may he executed on a digital signal processor, ASIC, microprocessor, or other type of processor operating on a computer system, such as a personal computer, server or other computer system, turning such computer system into a specifically programmed machine.

The functionality can he configured to perform an Operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware, The term, “logic” encompasses any functionality for performing a task. For instance, each operation illustrated in the flowcharts corresponds to logic for performing that operation. An operation can he performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Many new businesses or charitable organizations must purchase machines to process credit card transactions or establish a relationship to deposit checks received. Use of a credit card or writing a check can also he burdensome for individual wishing to purchase or donate and can be barriers to purchasing or donating.

These basic systematic challenges are further compounded when a small to medium-sized organization is attempting to raise funds for an “annual event” or “benefit walk.” Various embodiments of the present inventive subject matter provide an integrated, organized infrastructure platform that can be quickly, simply and safely deployed in a variety of settings to digitally connect donors to fundraising causes without the need for each organization to purchase point of sale equipment or set up web-based payment systems.

A streamlined system that takes care of the technical, creative, marketing and accounting challenges on the organization side allows a small team of less technologically advanced personnel to successfully setup and manage a fundraiser. The system platform provides multiple methods for donors to access easily access the organization donation page or pages.

By creating a platform that can provide a simple interface for the donor, organizations can benefit from increased engagement in the integrated—yet decentralized—giving process. There is a need to help a range of use cases from a church raising funds for a new piano, to the humane society raising funds for their mission or even a pediatric benefit-walk at the local park. Further use cases include the sale of products or services. The platform may he used to facilitate sale of items at a garage sale, startup business, or even established businesses and retail stores. The platform creates an integrated, simplified approach to these challenges.

The platform is a programmed computer that creates a code, such as an alphanumeric code, a bar code, a QR code, a geofenced boundary, an animated map or the like that can he received by a user device. Each code identifies a unique web page from which fund transfers may he performed via the user device. The web page provides options for payment, such as one or more buttons with varying amounts, or an amount that can be entered by the user. Selection of the amount causes funds to be transferred based on any payment mechanism specified by the user, such as Apple® Pay, Google® pay or others.

The code may he provided on marketing materials of the organization. In further embodiments, a product or service may utilize the same type of code with a unique web page for fund transfer, facilitating purchase of the product or service without any physical infrastructure or need to search for a product on-line.

The platform empowers organizations to easily create and organize their fundraising efforts and allows donors to quickly find and fund a given cause. This includes the use of short codes, QR codes, social media, geofencing technology, and a map-based interface that directs a user to a webpage created and customized on the platform specifically for donation or purchase. The codes may be communicated to a purchaser or donator device via camera scanning a QR code, bar code, text code, or any image from which a code can be derived. In further embodiments, the code may be communicated via NFC chip, RFID chip, beacons, or any other wireless means of providing a code associated with a product, service, fundraiser, funds transfer, or any other type of transaction. Receipt of such a communication results in a message being displayed on the user device that can be selected to send the code to the platform for navigating to the transaction/donation page. In still further embodiments, the code may be entered by a user via keyboard, touchscreen, voice, or other means of entering the code.

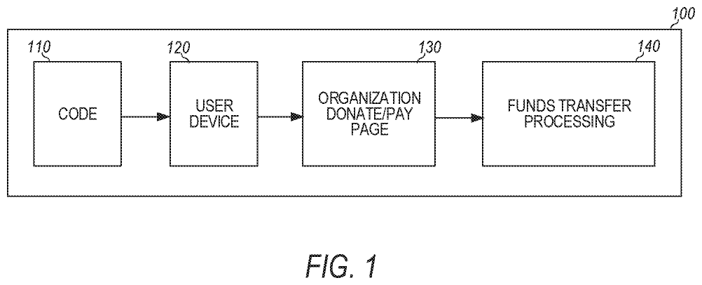

FIG. 1 is a flow diagram illustrating the use of a platform 100 for facilitating fundraising for organizations. A code 110 is provided to a user device 120. The code may take the form of a QR code, a short alphanumeric code, a bar code, a geofenced location, a social media link, a platform link, or any other construct which can be used to identify a link to a specific web page associated with donating or otherwise transferring funds between the user and an organization associated with the web page.

The code is received by the user device in a way that the link can be accessed by the user device. In the case of a QR code, many user devices, such as cell phones are already programmed to recognize a link identified via a QR code simply by having a camera of the device turned on. An icon corresponding to the link may be presented to the user, allowing the user to select the icon, and navigate to an organization's donate/pay page 130. Such a page may include buttons with selected amounts to donate or pay, which when selected by the user cause funds to be transferred at 140, which invokes a user selected payment method stored on the user device or other means of payment described below.

On the donor side, a variety of decentralized funding opportunities can he presented, but all funnel towards the organization's “Platform Page” URL hosted by the platform 100. From the Platform Page URL, donations are processed via payment services. Receipts are immediately sent to the donor and the transaction is saved within the payment processing preference determined by the organization. Donor contact information may be included in the selected payment mechanism. In some embodiments, the location of the user device 120 may he obtained from the user device 120 used to index into sales tax tables corresponding to the location to account for sales taxes that may he due and include that in the funds transferred.

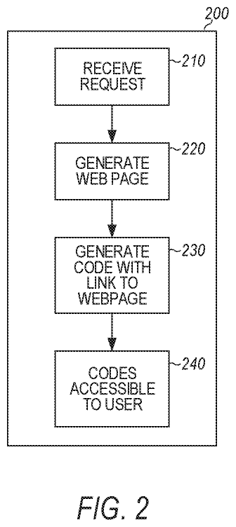

FIG. 2 is a flowchart illustrating a method 200, implemented by a platform server, of generating a code in response to a request from an organization. At operation 210, a request is received from an organization for a code. The code may be requested for a donation page for the organization. The request may indicate fund amounts for one or more donate buttons on a donate page. in further embodiments, the code may be requested for a page to purchase a product or service. The request includes the fund amounts or purchase price and is associated with the organization and/or information about the product.

At operation 220, a webpage for display on a user device is generated corresponding to the request, with one or more buttons associated with the product/service or donation amounts to effect a transfer of funds when selected. The webpage may also contain information about the organization, such as the name of the organization, and may also contain a single button with the price for purchase of the product or service. A field may he provided for entering an amount via the user device. The webpage has programming to interact with the user device to complete a fund transfer based on the button selected. The webpage is stored on one or more servers and has a corresponding URL or link which operates to provide access to the webpage.

In some embodiments, the webpage may be automatically generated from a template having multiple buttons, a field for the organization name/description, as well as programming to transfer funds to an identified account associated with the organization. The request may have a set format, such as fields filled in by the requester which correspond to the buttons and fields in the template, allowing simple automated generation of the webpage.

A code is also automatically generated at operation 230 and corresponds to the link to the webpage generated at operation 220. The code may be a next code in a known sequence of codes in one embodiment, such as a four-character code which may include alphanumeric characters in one embodiment. Different lengths of codes may be used in further embodiments, and the codes may be generated in many different ways, such as randomly without duplicates or specific requests without duplicates. Some organizations may have a set of codes with some common characters or not for use on different products or services, or even different sets of donors such that a different webpage may he associated with each different code.

The code is provided to the requester at operation 240, allowing the requestor to distribute the code by one or more communication mechanisms, such as entails, printed brochures, websites, social media, posters. letters, direct mail postcards, displays, television, radio and other marketing materials designed to reach potential donors and/or purchasers. The code may also be applied directly to products or packaging for products or services.

The code is provided to a server that correlates the code to a webpage. The server may also host the webpage using either an external link, or an internal link or address.

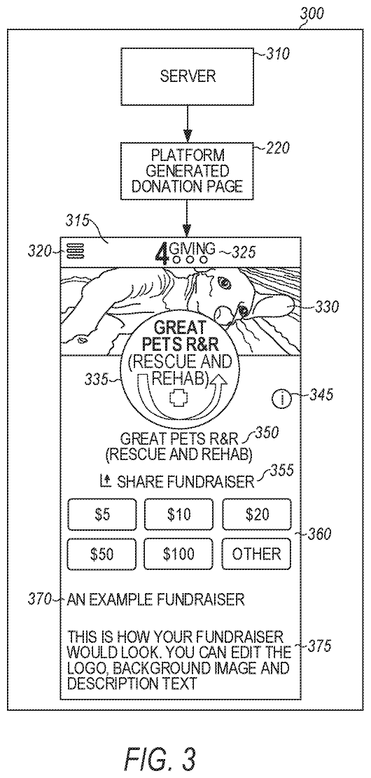

FIG. 3 at 300 represents a generated webpage embodiment where the organization can customize a variety of settings to provide information and payment options to a donor once a server 310 hosted page 220 has been accessed.

Standard platform features and customizations for the organization and donor are accessed through links within the header 315 of page 220. The organization and donor can access customizable profile information, page features and fund transfer history through link 320. Link 325 returns users to the platform home page. Persistent features generated on all pages include an easy to access informational link 345 describing terms and conditions of use, social media and link sharing 355 and donation buttons 360 in a configuration allowing immediate access once accessing the page.

Donation buttons 360 may be coupled to a payment mechanism, either on the mobile device or stored on the platform. Selection of a button causes transfer of funds from a donor account, such as a credit card or any other type of account in accordance with the amount associated with the selected button. The funds may he transferred directly to a specified organization account, or first to an account associated with the platform that may host multiple organization donation pages, and then appropriately distributed to the organization, allowing transaction fees to be deducted.

The organization account may he specified in association with requesting a code to set up a donor or other type of page for receiving funds, such as donations or product or services payments. Note that when a page is set up for a specific product, the payments for that product are associated with all the information used to set up the page, allowing precise accounting methods to be employed without the need for expensive point of sale equipment to consummate a sale.

On the organization side, link 320 allows customization to a variety of page features including a Fundraiser Banner Image 330, Organization Icon 335, Organization Name 350, Dollar Amounts within the donation buttons 360, Fundraiser Title 370, and Fundraiser Description 375.

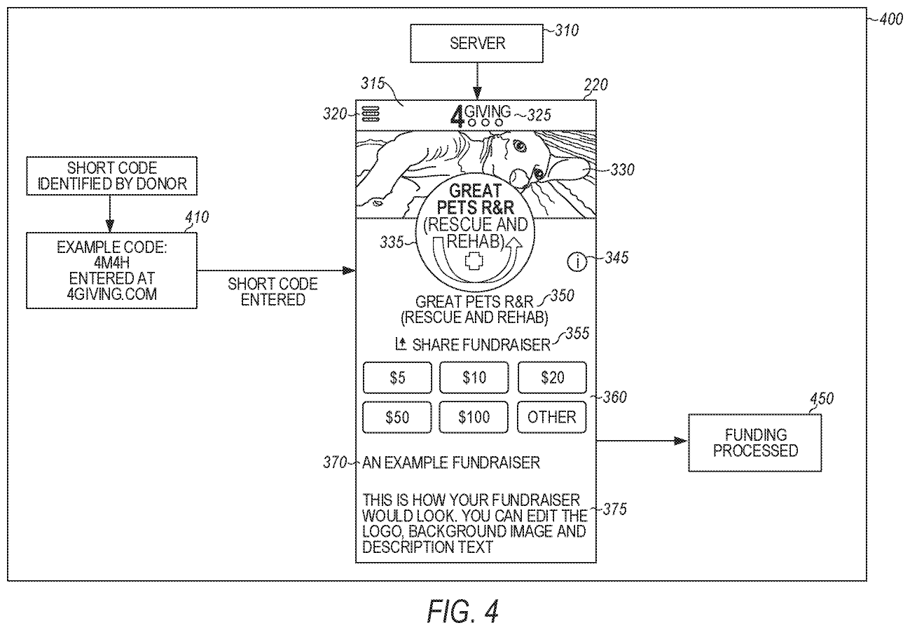

To integrate the user experience across a variety of methods to reach donors, different “front end” strategies may be supported by the platform infrastructure. FIGS. 4-8 represent different example approaches that result in a potential transaction.

In one embodiment as illustrated at 400 in FIG. 4, the automatically generated code 410 shown as “4M4H” for example, may he provided directly to an encrypted and securely hosted Platform Page server 310 via a URL for the server 310. The code is then used at the server 310 to access the associated donation webpage 220. Reference numbers for like elements are the same in the various figures. This short code 410 is entered at a Platform Home Page (in this example 4Giving.com). This allows an organization to advertise in virtually any form of media to compliment the other donation routes or even as a standalone route. The user experience is simple, as some may not be familiar with other platform technologies and entering a short code in a platform app, such as a 4Giving™ app on the user's phone that provides the code to the server 310 or entering the code at a server 310 hosted platform website is both simple and familiar. In some embodiments, the code may be recognized in an image captured by a camera and automatically used to access the corresponding webpage via the app.

This route essentially makes any advertisement for a fundraiser become an easily engaging donation opportunity. Organizations can therefore present. Short Codes on any form of visual media or audible media. This greatly simplifies and even enhances the experience for the organization and donor. For example, a short code pointing to a nature conservancy could accompany a documentary on deforestation concerns. If not providing the code via the 4Giving app. or directly at the 4Giving website, or other website using similar codes, the visual or wireless construct providing the code may also provide a link to the appropriate Platform Page sever home page, with the code then providing the navigation information to the donation/payment webpage 220.

Consistent with the platform infrastructure, once payment is processed, an email receipt is automatically generated for the donor and the organization will have the data organized for their accounting in the manner of their choosing (payment platform dependent).

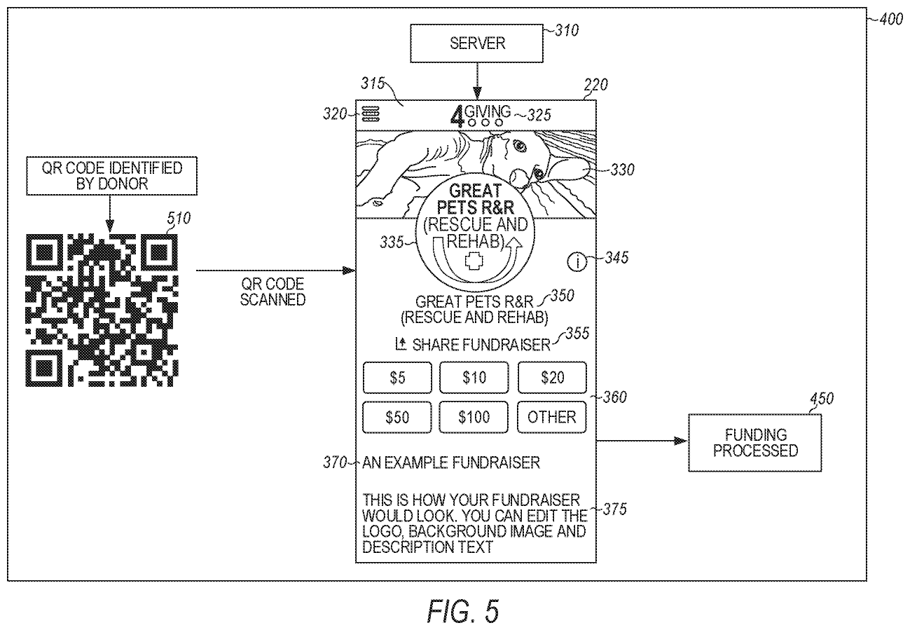

In FIG. 5 at 500, an automatically generated QR Code 510 points directly to an encrypted and securely hosted Platform Page server 310 URL, leading to the associated donation webpage 220 for display on a user device, also represented in FIG. 5 at 220. The user device 220 may be a mobile phone or touchpad or other networked device that includes a camera. This allows a user to simply point their mobile device camera at the code 510 and follow the resulting link to the page 220 displayed on mobile device. The page 220 includes an identification of the organization, including a logo in this example, as well as multiple donation buttons with amounts to transfer of 5, 10, 20, 50, 100, and other (can be filled in by the user or user device.) Selecting a button causes the amount to be transferred via processing block 350 utilizing user selected payment methods.

This essentially makes any advertisement for a fundraiser become an immediately engaging donation opportunity without the need to enter, remember or document information. Organizations can therefore present QR Codes on any form of visual media. This greatly simplifies the engagement experience for both the organization and donor.

Consistent with the platform infrastructure, once payment is processed, an email receipt is automatically generated for the donor based on the amount and donor contact information provided during the payment process and associated with the user payment mechanism. The organization will have the data organized for their accounting in the manner of their choosing (payment platform dependent).

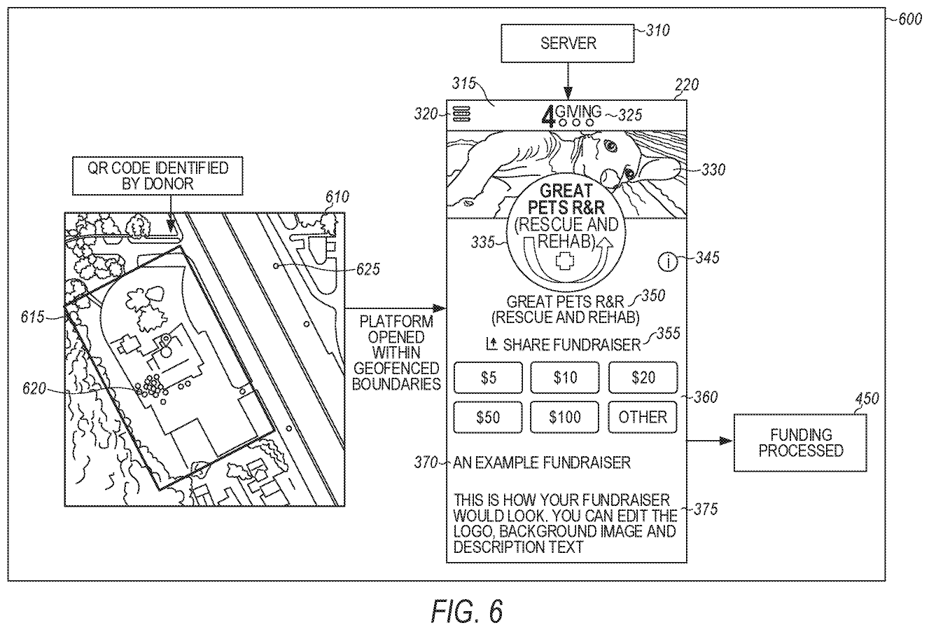

In one embodiment depicted in FIG. 6 at 600, Geofenced locations may be determined by defining specific boundaries or defining a radius around a chosen location for a defined set of time. An image of a location 610 is shown with a boundary shown at 615, corresponding to a Geofenced location, which appears as a lighter shaded substantially rectangular area to the left of the highway. The boundary may be specified using GPS coordinates at the corners. Dots 620 within the boundary 615 correspond to potential donors, while dots 625 outside of the boundary 615 correspond to potential donors outside of the boundary 615. When a user is within the defined boundary, they can then open the platform page (in this case 4Giving.com) and are prompted to accept or decline sharing location information. If accepted, the user can then choose to go to the Platform Donation Page. If outside of the geofenced boundary. no prompt for the page will be offered.

Alternatively, a beacon may he used to identify a chosen location. The beacon may broadcast the availability of the platform page and an associated Platform Donation Page.

This route essentially makes simply being “in person” and “on location” at a geofenced or beaconed event the route for the donation experience to happen. Without entering information, and by simply accepting an automatic platform location prompt, a user will have the donation experience available.

Consistent with the platform infrastructure, once payment is processed, an email receipt is automatically generated for the. donor and the organization will have the data organized for their accounting in the manner of their choosing (payment platform dependent).

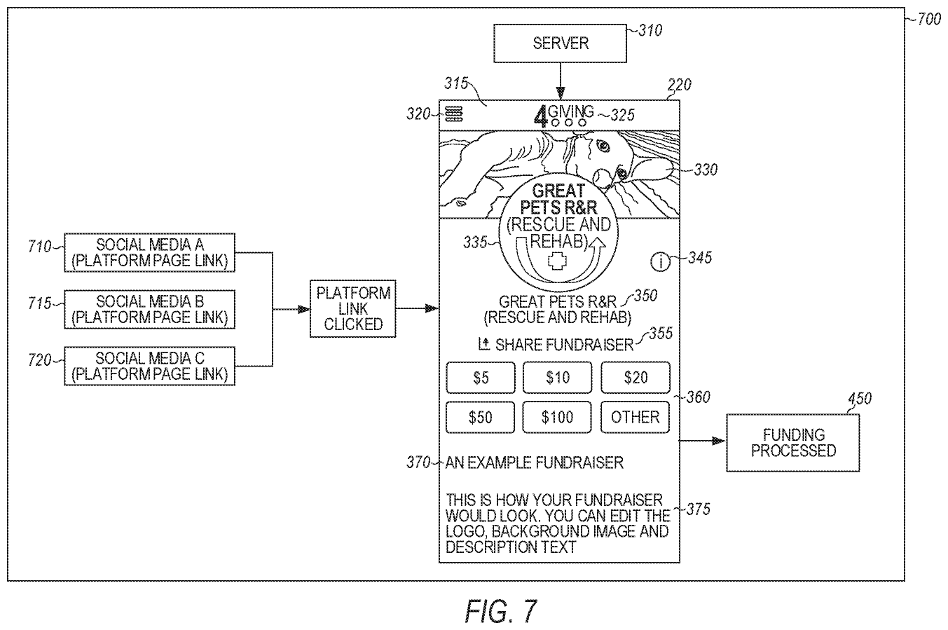

FIG. 7 illustrates a feature for promotion of codes/links via social media and texting at 700. Multiple different social media platforms may be used as indicated at 710, 715, and 720 by liking, texting, forwarding, sharing, and other mechanisms. Sharing a link allows for donors and organizations to directly share and further promote the fundraising site. Sharing the code allows those using the platform, either via the platform app, or directly via the platform website to donate conveniently. This feature is available within the donation page and within a backend infrastructure (dashboard) available to the organization. Since social media experiences are common and multigenerational, the ability to quickly and easily share the Platform donation page link widely across texting and social media is familiar and easily accessible.

The platform app facilitates the various mechanisms for accessing the donation pages, including via QR codes, entry of code characters, geofenced boundaries, and may be easily modified to facilitate other methods. The platform app can he tied to the platform server and transfers the code to the server in order to navigate to the page in some embodiments. The platform app may provide a screen with a button for scanning a code. When selected, the camera turns on and scans a code within the camera's field of view. Once scanned, the characters encoded in the code are decoded and the app sends the code to the platform server, causing display of the corresponding platform donation page. Note that the code may include just a short code, such as four characters that is sent to the server, or the entire IP address to the donation page facilitating the creation of millions or more donation pages for fundraising as well as service and product sales.

The platform app may also contain a field or fields for manual. entry of the code, resulting in the same navigation to the server, resulting in display of the corresponding donation page. In still further embodiments, the platform app may include a button for scanning text within the field of view of the camera and extracting the code from the scanned text. The platform app may also include a history of donations in further embodiments.

Consistent with the platform infrastructure, once payment is processed, an email receipt is automatically generated for the donor and the organization will have the data organized for their accounting in the manner of their choosing (payment platform dependent).

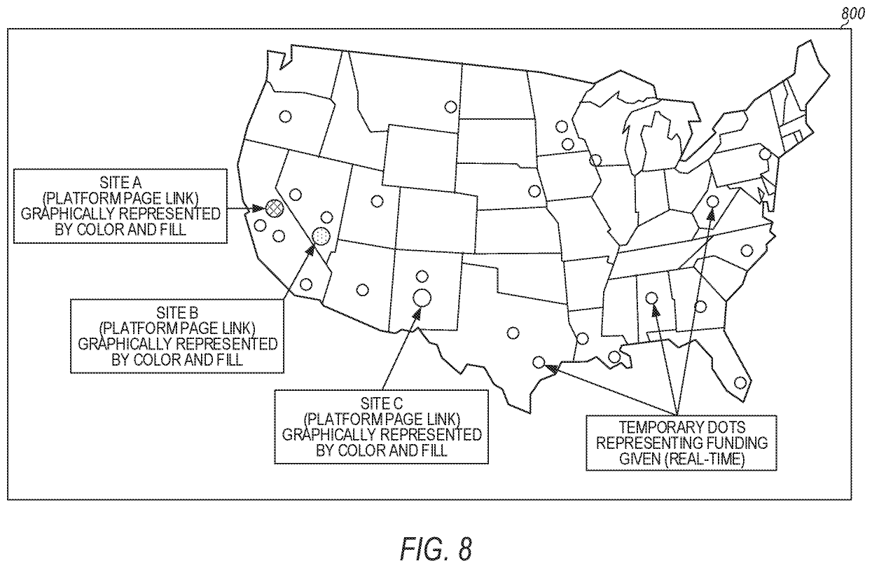

FIG. 8 is a diagram of a virtual map 800 of all active platform donation locations. Donation locations may be graphically represented both by color coding of a given category of cause (Environmental, Humanitarian, Educational, etc.) and a fill ratio indicating the level of “completeness” of a given fundraiser. The virtual map 800 allows potential donors to search for causes of personal importance, unbounded by geography, and gives the donor the flexibility to “virtually” he there and interact with their cause of interest. Once a page is chosen, the donor can fund the cause. Once a successful transaction is processed, their general location (within zip code) will be graphically represented as a temporary “dot” on the same map. Therefore, the map can act as a centralized setting for both organizations and donors to “find each other” and inspire further moments of generosity through precisely donating to the cause of their choice and observing the acts of generosity occurring throughout the country at any given moment. User “dots” can be customized and take on the appearance of their most frequently donated to causes.

Consistent with the platform infrastructure, once payment is processed, an email receipt is automatically generated for the donor and the organization will have the data organized for their accounting in the manner of their choosing (payment platform dependent).

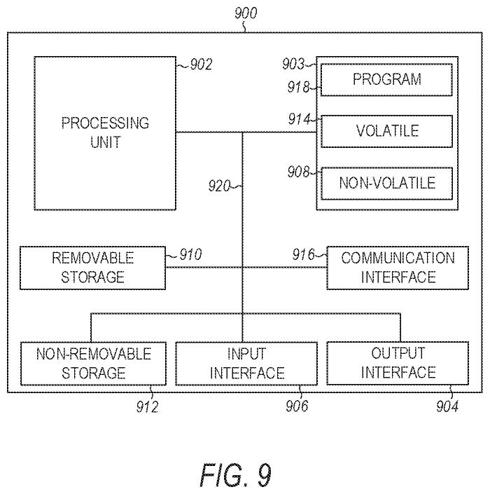

FIG. 9 is a block schematic diagram of a computer system 900 to implement and manage the use of codes for simplifying donation and purchasing mechanisms and for performing methods and algorithms according to example embodiments. All components need not he used in various embodiments. For instance, servers and web hosting computers may utilize more components than user devices.

One example computing device in the form of a computer 900 may include a processing unit 902, memory 903, removable storage 910, and non-removable storage 912. Although the example computing device is illustrated and described as computer 900, the computing device may be in different forms in different embodiments. For example, the computing device may instead be a smartphone, a tablet, smartwatch, smart storage device (SSD), or other computing device including the same or similar elements as illustrated and described with regard to FIG. 9. Devices, such as smartphones, tablets, and smartwatches, are generally collectively referred to as mobile devices or user equipment.

Although the various data storage elements are illustrated as part of the computer 900, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 903 may include volatile memory 914 and non-volatile memory 908. Computer 900 may include or have access to a computing environment that includes a variety of computer-readable media, such as volatile memory 914 and non-volatile memory 908, removable storage 910 and non-removable storage 912. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 900 may include or have access to a computing environment that includes input interface 906, output interface 904, and a communication interface 916. Output interface 904 may include a display device, such as a touchscreen, that also may serve as an input device. The input interface 906 may include one or more of a touchscreen, touchpad, mouse, keyboard, camera, one or more device-specific buttons, one or more sensors integrated within or coupled via wired or wireless data connections to the computer 900, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 900 are connected with a system bus 920.

Computer-readable instructions stored on a computer-readable medium arc executable by the processing unit 902 of the computer 900, such as a program 918. The program 918 in some embodiments comprises software to implement one or more of the methods described herein. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 918 along with the workspace manager 922 may be used to cause processing unit 902 to perform one or more methods or algorithms described herein.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may he added to, or removed from, the described systems. Other embodiments may be within the scope of the following claims.

1. A computer implemented method comprising:
receiving a code at a user device, the code identifying an organization page corresponding to the code;
providing the code to a webpage server, wherein the server accesses the organization page corresponding to the code;
receiving and displaying the organization page on the user device, wherein the organization page includes at least one funds transfer selection mechanism;
receiving a funds transfer amount via the at least one funds transfer selection mechanism at the user device; and
sending the selection to the server to transfer funds from a user account to an organization account in response to the received selection.

2. The method of claim I wherein receiving the code comprises capturing an image of a QR code that encodes an alphanumeric code.

3. The method of claim l wherein the code comprises an alphanumeric code that does not identify the webpage server.

4. The method of claim l wherein receiving the code comprises receiving an indication of a geofenced location, receiving a signal from a beacon, receiving a social media link, or receiving a donation web page server link.

5. The method of any one of claims 1 wherein an app executing on the user device facilitates receiving the code and providing the code to the webpage server.

6. The method of claim 5 wherein the code is decoded to provide an alphanumeric code and wherein the alphanumeric code is provided to the webpage server via app to access the organization page.

7. The method of claim 6 wherein the alphanumeric code is a four or five-character code and wherein the organization page comprises a charitable donation page.

8. A user device comprising:
a processor; and
a memory device coupled to the processor and having a program stored thereon for execution by the processor to perform operations comprising:
receiving a code at the user device, the code identifying are organization page corresponding to the code;
providing, via the user device, the code to a webpage server, wherein the server accesses the organization page corresponding to the code;
receiving and displaying the organization page on the user device;
receiving a selection of an amount at the user device; and
sending the selection to the webpage server to cause transfer of funds from a user account to an organization account in response to the received selection.

9. A computer readable storage device having instructions stored thereon for causing processing resources to perform operations comprising:
receiving a code at a user device, the code identifying an organization page corresponding to the code;
providing the code to a webpage server, wherein the server accesses the organization page corresponding to the code;
receiving and displaying the organization page on the user device;
receiving a selection of an amount of funds at the user device; and
sending the selection to the server to transfer the amount of funds from a user account to an organization account in response to the received selection.

10. The device of claim 9 wherein the code comprises a QR code that encodes an alphanumeric code and wherein receiving the code comprises using a user device camera to capture a photograph of the QR code.

11. The device of claim 9 wherein the code corn rises an alphanumeric code.

12. The device of claim 9 wherein receiving the code comprises receiving an indication of a geofenced location, receiving a signal from a beacon, receiving a social media or receiving a donation web page server link.

13. The device of any one of claims 9 wherein the instructions comprise an app on the user device to facilitate receiving the code and providing the code to the server.

14. The device of claim 13 wherein the code is decoded to provide an alphanumeric code and wherein the alphanumeric code is provided to the server via the app to access the organization page.

15. The device of claim 14 wherein the alphanumeric code is a four-character code.
